(19) United States
(12) Patent Application Publication
(10) Pub. No.: US 2009/0037678 A1
(43) Pub. Date: Feb. 5, 2009

(54) PROTECTED PORTION OF PARTITION MEMORY FOR COMPUTER CODE

(76) Inventors: Chris M. GILES, Lafayette, CO (US); Bryan Hornung, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/868,772

(22) Filed: Oct. 8, 2007

Related U.S. Application Data
(63) Continuation-in-part of application No. 11/830,909, filed on Jul. 31, 2007.

(51) Int. Cl. G06F 12/00

(52) U.S. Cl. 711/162

(57) ABSTRACT

A system comprises a plurality of computing nodes and a plurality of separate memory devices. A separate memory device is associated with each computing node. The separate memory devices are configured as partition memory in which memory accesses are interleaved across multiple of such memory devices. A protected portion of the partition memory is reserved for use by complex management (CM) code that coordinates partitions implemented on the system. The protected portion of partition memory is restricted from access by operating systems running in the partitions.

### CROSS-REFERENCE TO RELATED APPLICATIONS

This application is a continuation-in-part of, and claims priority to, U.S. patent application Ser. No. 11/830,909, filed Jul. 31, 2007, incorporated herein by reference. All claims of this continuation-in-part application are entitled to the priority date of application Ser. No. 11/830,909.

### BACKGROUND

At least some partitionable computer systems comprise complex management (CM) code that manages the system at a high level. The CM code supports partitioning of the system. For example, the CM code is used to spawn various partitions in the system. Viruses, bugs, or rogue applications could compromise the integrity and operability of the system if such applications had access to the CM code.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a software hierarchy description of the system in accordance with various embodiments;

FIG. 3 depicts partition memory and CM memory “owned” by CM code contained therein in accordance with various embodiments; and

FIG. 4 illustrates a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

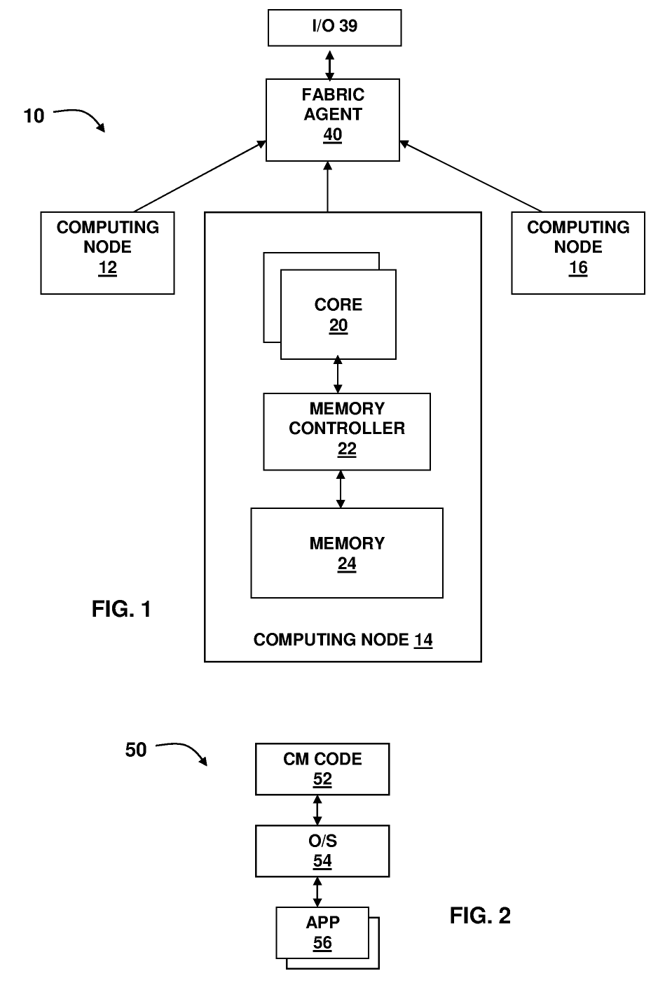

FIG. 1 illustrates a system 10 in accordance with various embodiments. As shown, system 10 comprises one or more computing nodes 12, 14, and 16 coupled together by way of a fabric agent 40. Any number of computing nodes can be provided. Each computing node comprises, as illustrated with respect to computing node 14, one or more processor cores 20, one or more memory controllers 22, and a memory device 24. The memory device 24 may comprise multiple dual in-line memory modules (DIMMs).

Each processor core 20 executes one or more operating systems and applications running under the respective operating systems. Via the memory controllers 22, the cores 20 issue memory requests (e.g., reads, writes) for access to the memory 24. The memory controllers 22 arbitrate among multiple pending memory requests for access to the memory 24. The system 10 may also include I/O devices and subsystems 39 accessible to, for example, the fabric agent 40. The memory requests discussed herein may also originate from such I/O devices and subsystems.

The memory 24 contained in each computing node is configured, in at least some embodiments, as “partition memory” meaning that memory requests for such memory are interleaved across the memory of multiple computing nodes. By interleaving memory requests across all memory controllers in the partition, an application does not have to be aware of the non-uniform memory access (NUMA) characteristics of the system to achieve satisfactory performance of a symmetric multi-processing (SMP) system.

In various embodiments, the system 10 is “partitionable” meaning that the various computing nodes 12-16 are configured to operate in one or more partitions. A partition comprises various hardware resources (e.g., core 20, memory controller 22, memory 24, and input/output (I/O) resources) and software resources (operating system and applications). Different partitions may run the same or different operating systems and may run the same or different applications.

FIG. 1 also shows a fabric agent 40. The fabric agent 40 receives or otherwise coordinates partition memory requests from the various computing nodes 12-16, and I/O devices and subsystems 39, and translates the partition memory addresses into “fabric” addresses. The partition memory is accessed by way of fabric addresses. The use of fabric addresses enables DIMMs in the computing nodes to be removed and replaced as desired without impacting the computation by the computing node cores of the partition memory addresses. After translating a partition memory address to a fabric address, the fabric agent 40 permits the corresponding memory request to complete by the appropriate memory controllers 22. In some embodiments, a single fabric agent 40 is provided, while in other embodiments, multiple fabric agents 40 are provided (e.g., one fabric agent for each computing node).

Executable code termed “complex management (CM) code is executed by one or more of the cores 20 to coordinate the various partitions implemented on the system 10. The CM code spawns the various partitions and reconfigures the partitions as needed upon the hot addition or deletion of hardware resources (e.g., memory 24).

FIG. 2 shows a software hierarchy 50 in accordance with various embodiments. One or more applications 56 in a partition run under a respective operating system 54 of that partition. The operating system 54 is subordinate to the CM code 52. Thus, the CM code runs outside the control of the operating system. In various embodiments, the CM code 52 is stored in the partition memory and executed therefrom.

The CM code 52 is run in a performant manner. If the CM code is stored within system memory, such code should be rapidly accessible. Additionally, the CM code requires data stores within system memory that can be rapidly and nearly uniformly accessed. The memory region hosting the CM code and the data stores used by the CM code is termed “Complex Management Interleaved” (CMI) as the interleaved nature of the region addresses the performance requirements.

Because the CM code 52 runs outside the control of the operating systems 54 in the various partitions, security mechanisms that the operating systems may implement will generally not be effective to protect the security of the CM code 52. Because the CMI region requires interleaved memory support, the CMI region will generally use the infrastructure provided for partition memory. Thus, in accordance with various embodiments, a portion of partition memory also hosts the CMI memory region. The portion of partition memory in which the CMI region resides is restricted from access by operating systems 54 running in the various partitions.

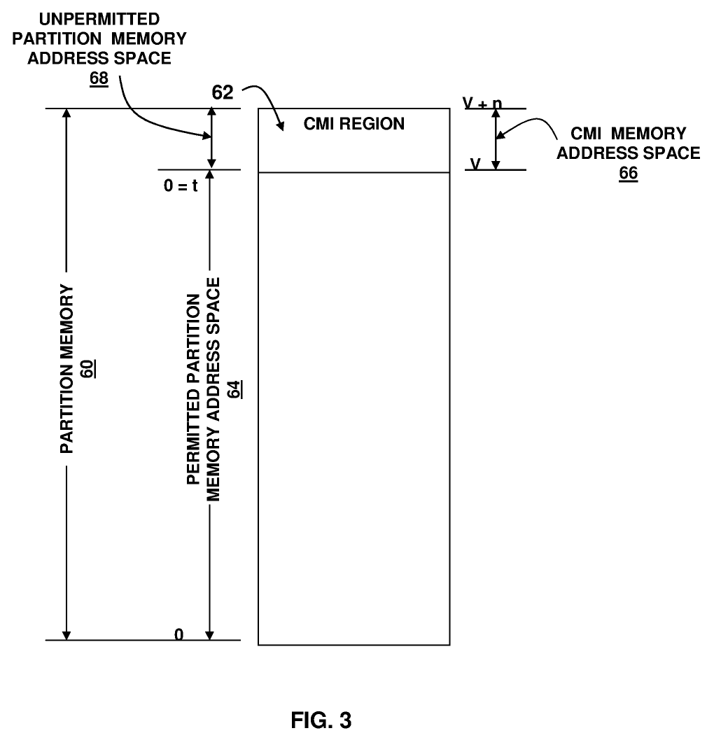

FIG. 3 illustrates an embodiment of partition memory 60. A portion 62 of the partition memory is reserved for use by the CM code 52 and is called Complex Management Interleave (CMI) memory. In the embodiment depicted in FIG. 3, the CMI-specific portion 62 of partition memory 60 is reserved at the top of the partition memory 60. By way of an example, partition memory 60 comprises 1 GB of memory and the portion 62 reserved for exclusive use by the CM code 52 comprises the top 64 MB of the partition memory. The portion 62, however, can be at a location other than the top of the partition memory 60.

In the embodiment of FIG. 3, the partition memory 60 is divided into a permitted partition memory address space 64 and a CMI memory address space 66. The permitted partition memory address space 64 comprises a range of address from, for example, 0 to 0+t, as shown. The CMI memory address space comprises a range of addresses from, for example, V to V+n. The addresses of the permitted partition memory address space 64 and the CMI memory address space 66 are different and thus do not overlap. The fabric agent 40 translates addresses from the permitted partition memory address space 64 and from the CMI memory address space 66 to fabric addresses to enable such memory requests to complete.

In at least some embodiments, the CMI memory address space 66 is smaller than the smallest granule of memory assignable to the various partitions. Any memory assigned to CMI is not available to operating systems or applications. A different protection mechanism that uses a smaller granularity than the mechanism used to protect memory from other partitions can be implemented as desired.

In the partition memory address space, the range of addresses just above the permitted partition memory address space 64 represents partition memory addresses that are not permitted (unpermitted partition memory address space 68). The unpermitted partition memory address space 68 would alias (i.e., by translation of such addresses to fabric accesses) to the same CMI region 62 as the CMI memory address space 66. The addresses of the unpermitted partition memory address space 68 and the CMI memory address space 66 are different and thus do not overlap, but alias to the same CMI region 62.

As the name suggests, the unpermitted partition memory address space 68 is not permitted as part of the partition memory address space. Such addresses are not reported as being available to the various partitions and operating systems running therein. The CMI memory address space 66 comprises addresses, which alias to the CMI region 62, that are available by a processor core 20 for execution of the CM code 52 or for access to other CMI-protected data, but only when the processor core 20 is in a complex management (CM) mode of operation. The processor core 20 is caused to transition to the CM mode in accordance with any suitable technique. When a processor core 20 is in the CM mode, that core is permitted to generate CMI addresses for executing the CM code 52 and accessing the rest of the CMI region 62, for access of CM data. When the fabric agent 40 receives an address that is in the CMI memory address space 66, the fabric agent 40 permits such address and associated memory request to complete. In that regard, the fabric agent 40 translates the received CMI memory address to a fabric agent.

As explained above, unpermitted partition memory address space addresses are different than CMI memory address space addresses, and thus can readily be detected and differentiated by, for example, the fabric agent 40, from CMI memory addresses in the CMI memory address space 66. Partition memory addresses in the unpermitted partition memory address space 68 were generated by a processor core 20 that was not in the CM mode. Such address references cannot be trusted. Thus, any partition memory address space address that the fabric agent 40 receives that would alias to the CMI region 52 upon being translated to a fabric address is not permitted and the fabric agent blocks such memory requests from completing. In at least some embodiments, the fabric agent 40 blocks such requests by not permitting the requests to complete and by generating a signal or message that indicates that the occurrence of an address in the unpermitted partition memory address space 68. Such an occurrence may be indicative of a virus, a bug, or other type of malfeasance or inadvertent error.

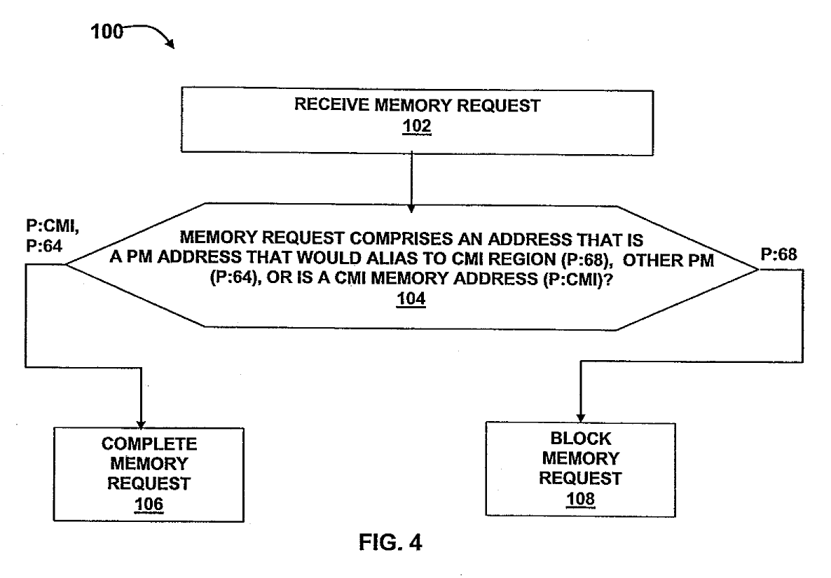

FIG. 4 illustrates a method 100 in accordance with various embodiments. At 102, method 100 comprises the fabric agent 40 receiving a memory request which may contain an address in the partition memory address space or in the CMI memory address. If the address is in the partition memory address, that address may be in the permitted or unpermitted partition memory address spaces 64 or 68, respectively. In FIG. 4, a partition memory address in the permitted partition memory address space 64 is referred to as “P:64,” while a partition memory address in the unpermitted partition memory address space 68 is referred to as “P:68.” An address in the CMI memory address space 66 is referred to as “P:CMI” in FIG. 4.

At 104, method 100 comprises determining whether the address in the memory request is an address in the permitted partition memory address space 64 (P:64), the unpermitted partition memory address space 68 (P:68) or the CMI memory address space 66 (P:CMI). The memory request is permitted to complete at 106 if the address that is the target of the memory request is P:CMI or P:64. A memory request containing an P:68 address (i.e., an address in the unpermitted partition memory address space 68) is blocked from completing at 108.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a plurality of computing nodes; and
a plurality of separate memory devices, a separate memory device associated with each computing node, said separate memory devices configured as partition memory in which memory accesses are interleaved across multiple of such memory devices;
wherein a protected portion of said partition memory is reserved for use by complex management (CM) code that coordinates partitions implemented on said system, and said protected portion of partition memory is restricted from access by operating systems running in said partitions.

2. The system of claim 1 further comprising an agent coupled to said computing nodes that blocks attempted access to said protected portion of the partition memory.

3. The system of claim 1 further comprising a partition memory range and a complex management interleaved (CMI) memory address range, said partition memory and CMI memory address ranges do not overlap, wherein said CMI memory address range corresponds to said protected portion.

4. The system of claim 3 further comprising an agent coupled to said computing nodes that blocks attempted access to said protected portion of the partition memory from partition memory space address.

5. The system of claim 1 wherein each computing node comprises a processor, and a processor core can only access said protected portion of the partition memory space when such processor core is in a complex management (CM) mode.

6. The system of claim 5 wherein the CM mode comprises a mode that enables the processor core to execute the CM code.

7. The system of claim 1 wherein the CM code spawns partitions in the various computing nodes.

8. A system, comprising:
means for determining whether a memory request comprises an address that is a partition memory address or a complex management interleave (CMI) memory address; and
means for completing said memory request if said address is a CMI memory address; and
means for blocking said memory request from completing if said address is a partition memory address that would alias to a protected region of partition memory reserved for use by complex management (CM) code;
wherein said CM code manages partitions implemented in said system.

9. The system of claim 8 further comprising means for generating the memory request to include the CMI memory address.

10. The system of claim 8 further comprising means for transitioning a processor to be in a CM mode, said CM code can only be run by a processor that is in the CM mode.

11. The system of claim 10 wherein the processor generates the memory request to include the CMI memory address only if the processor is in the CM mode.

12. The system of claim 8 wherein said memory request comes from an operating system running in a partition.

13. The system of claim 12 further comprising means for blocking said operating system memory request.

14. A method, comprising:
determining whether a memory request comprises an address that is a partition memory address or a complex management interleave (CMI) memory address; and
completing said memory request if said address is a CMI memory address; and
blocking said memory request from completing if said address is a partition memory address that would alias to a protected region of partition memory reserved for use by complex management (CM) code;
wherein said CM code manages partitions implemented in a computer system.

15. The method of claim 14 further comprising generating the memory request to include the CMI memory address.

16. The method of claim 14 further comprising transitioning a processor to be in a CM mode, said CM code can only be run by a processor that is in the CM mode.

17. The method of claim 16 further comprising the processor generating the memory request to include the CMI memory address only if the processor is in the CM mode.

18. The method of claim 14 wherein said memory request comes from an operating system running in a partition.

19. The method of claim 18 further comprising blocking said operating system memory request.
